(19) United States
(12) Patent Application Publication
(10) Pub. No.: US 2008/0290840 A1
(43) Pub. Date: Nov. 27, 2008

(54) Power dissipation limiting for battery chargers

(75) Inventors: Christopher Paul, Bayport, NY (US); Mark Duron, East Patchogue, NY (US); Nathan Meryash, Manhasset, NY (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/802,211

(22) Filed: May 21, 2007

(51) Int. Cl. H02J 7/04

(52) U.S. Cl. 320/162

(57) ABSTRACT

Methods, systems, and apparatuses for charging a battery in a mobile device are described. In embodiments described herein a power supply voltage and/or a power supply current of a power supply coupled to charger of the mobile is reduced. The reduction in power supply voltage and/or current results in a reduction in heat dissipation and power dissipation by the charger.

### BACKGROUND OF THE INVENTION

1. Field of the Invention

The present invention relates to battery powered devices, and in particular to mobile devices powered by rechargeable batteries.

2. Background Art

A variety of types of mobile devices exist, such as handheld computers (e.g., PDAs, BLACKBERRY devices, PALM devices, etc.), laptop computers, handheld barcode scanners, cell phones, handheld radio frequency identification (RFID) readers, handheld music players (e.g., IPODs), etc. Batteries are typically required for the operation of such mobile devices, such as rechargeable batteries. Battery chargers are required to recharge the rechargeable batteries for such devices, and there are a number of advantages to deploying battery chargers directly within such devices. Example advantages include the shielding of the battery terminals in the device from being accidentally shorted by a user of the device, and a minimizing of a resistance in a path between the charger and the battery (which results in a reduced charge time).

Attempts have been made to minimize the size of components in mobile devices, to maintain ease of mobility. As a result, linear integrated circuit (IC) types of battery chargers may be used in devices rather than a more efficient (and cooler) switching IC for the battery charger, which requires a large inductor and capacitor. However, heat generated by linear IC battery chargers can be a problem, especially when a voltage difference across the linear IC charger is relatively large. Such generated heat can be damaging to the mobile device. The generated heat and the voltage difference are typically at their greatest when a (typically) fixed power supply voltage powers the linear IC when it is charging a mostly discharged battery cell.

Thus, what is desired are mobile devices powered by rechargeable batteries that do not generate excessive heat when being charged by their battery recharger.

### BRIEF SUMMARY OF THE INVENTION

Methods, systems, and apparatuses for charging a battery in a mobile device are described. In an embodiment, a system for charging a battery of a mobile device includes a limited power supply. The limited power supply includes a limiter module and a monitoring module. The limiter module is configured to limit a power supply voltage of the limited power supply based on observations of a battery voltage taken by the monitoring module. The limited supply may be located outside of the mobile device.

In a further embodiment the limiter module is configured to update the power supply voltage so that the power supply voltage remains substantially equal to the minimum voltage required by a charger of the mobile device to charge the battery. In a still further embodiment, the limiter module is configured to update the power supply voltage according to:

V_{LPV}=V_{LO} when V_{LO}>V_{B}+V_{DO}, and V_{B}+V_{DO}, when V_{B}+V_{DO}≧V_{LO}, where

V_{LPV} is the power supply voltage,

V_{B} is the voltage of the battery,

V_{LO} is the lockout voltage of the charger, and

V_{DO} is the dropout voltage of the charger.

In another embodiment, a system for charging a battery of a mobile device includes a limited power supply. The limited power supply is coupled to a charger of the mobile device. The power supply is configured to supply a current less than or equal to a limited current. The limited power supply is preprogrammed such that the limited current is less than a current that the charger is configured to demand. The limiter module is configured to reduce a power supply voltage of the limited power supply if a current demanded by the charger is greater than the limited current.

In a further embodiment, the charger circuit includes a pass element. The limited power supply is configured such that the reduced power supply voltage starves the pass element of the charger if the charger demands a current larger than the limited current so that the charger charges the battery with a current substantially equal to the limited current.

In a further embodiment, the reduced voltage may be expressed as:

V_{RV}=V_{LO} when V_{LO}>V_{B}+V_{LIM}, and V_{B}+V_{LIM}, when V_{B}+V_{LIM}≧V_{LO}, where

V_{RV} is the reduced voltage,

V_{LO} is the lockout voltage of the charger,

V_{B} is the voltage of the battery, and

V_{LIM} is a minimum voltage drop across the charger such that the charger can charge the battery with a current equal to the limited current

A main benefit the methods and systems presented here is to reduce the power dissipated by a charger in a mobile device by minimizing the voltage drop across the charger. These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an example conventional battery charging system for a mobile device.

FIGS. 2-4 show example conventional battery charging waveforms.

FIG. 5 shows a battery charging system for a mobile device, according to an example embodiment of the present invention.

FIGS. 6 and 7 show example battery charging waveforms, according to embodiments of the present invention.

FIG. 8 shows a battery charging system for a mobile device, according to an example embodiment of the present invention.

FIGS. 9 and 10 show example battery charging waveforms, according to embodiments of the present invention.

FIGS. 11 and 12 show example steps for charging a battery, according to embodiments of the present invention.

FIG. 13 shows a mobile device, according to an example embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,”

“below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

### Example Embodiments

Methods, systems, and apparatuses for charging a battery in a mobile device are described. The example embodiments described herein are provided for illustrative purposes, and are not limiting. The examples described herein may be adapted to any type of mobile device. Further structural and operational embodiments, including modifications/alterations, will become apparent to persons skilled in the relevant art(s) from the teachings herein.

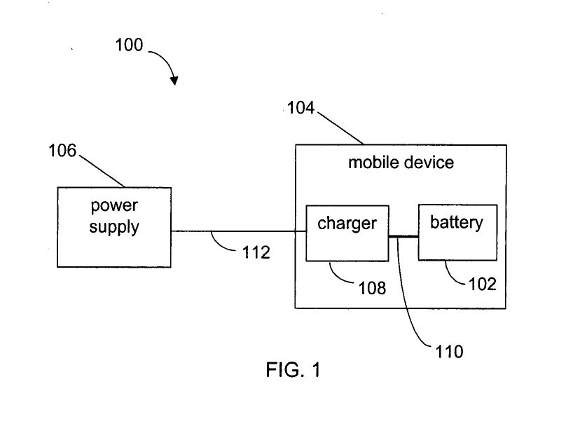

FIG. 1 shows a conventional charging system 100 for charging a battery 102 in a conventional mobile device 104. As shown in FIG. 1, system 100 includes a power supply 106 and a charger 108. In FIG. 1, battery 102 and charger 108 are located in mobile device 104, and power supply 106 is external to mobile device 104. Battery 102 is a rechargeable battery, such as a lithium ion or lithium polymer cell. Charger 108 is a conventional battery charger, such as a power switching charger or linear integrated circuit (IC) type charger, as would be known to persons skilled in the relevant art(s).

In powering charger 108, power supply 106 is said to supply charger 108 with a power supply voltage and a power supply current. Although the power supply voltage and current may be described separately, it would be apparent to those skilled in the art, that power supply 106 must supply charger 108 with both throughout the charging of battery 102.

Voltages relating to components, as described herein, are assumed to be measured relative to a ground of that component, unless otherwise noted. For example, the power supply voltage of power supply 106 is assumed to be measured relative to a ground of power supply 106. In an embodiment, charging system 100 is configured such that the ground of power supply 106, a ground of battery 102, and a ground of charger 108 are at the same potential.

Charger 108 requires a certain input voltage from power supply 106 (i.e., the power supply voltage) to charge battery 102. In an embodiment, charger 108 requires an input voltage of the power supply to remain equal to or larger than a lockout voltage of the charger 108, V_{LO}. Moreover, charger 108 also requires the input voltage from power supply 106 be larger than the voltage of battery 102 by at least a dropout voltage, V_{DO}, of charger 108. The dropout and lockout voltages of charger 108 may be determined based on suitable inspection of a datasheet associated with charger 108. The minimum voltage, then, that charger 108 must be supplied with to charge battery 102, may be expressed as:

V_{PSMIN}=V_{LO} when V_{LO}>V_{B}+V_{DO}, and V_{B}+V_{DO}, when V_{B}+V_{DO}>V_{LO}.

where V_{PSMIN} is the minimum power supply voltage, and

V_{B} is the voltage of the battery.

During different points of the charging of battery 102, charger 108 demands a current at levels defined by logic within charger 108. In contrast to the voltage requirement, charger 108 is able to charge the battery with a current that is less than the demanded current.

Power supply 106 powers charger 108 through a coupling 112. Charger 108 charges battery 102 through a coupling 110 by converting the power supply voltage and current provided by power supply 106 to a voltage and current appropriate for charging battery 102. Coupling 110 couples to battery 102 through first and second contacts that couple to positive and negative terminals of battery 102, as would be known to persons skilled in the relevant art(s).

Power supply 106 is configured to operate as a voltage controlled power supply. Power supply 106 satisfies the current demanded by charger 108 during all phases of charging and supplies a power supply voltage at a predefined value.

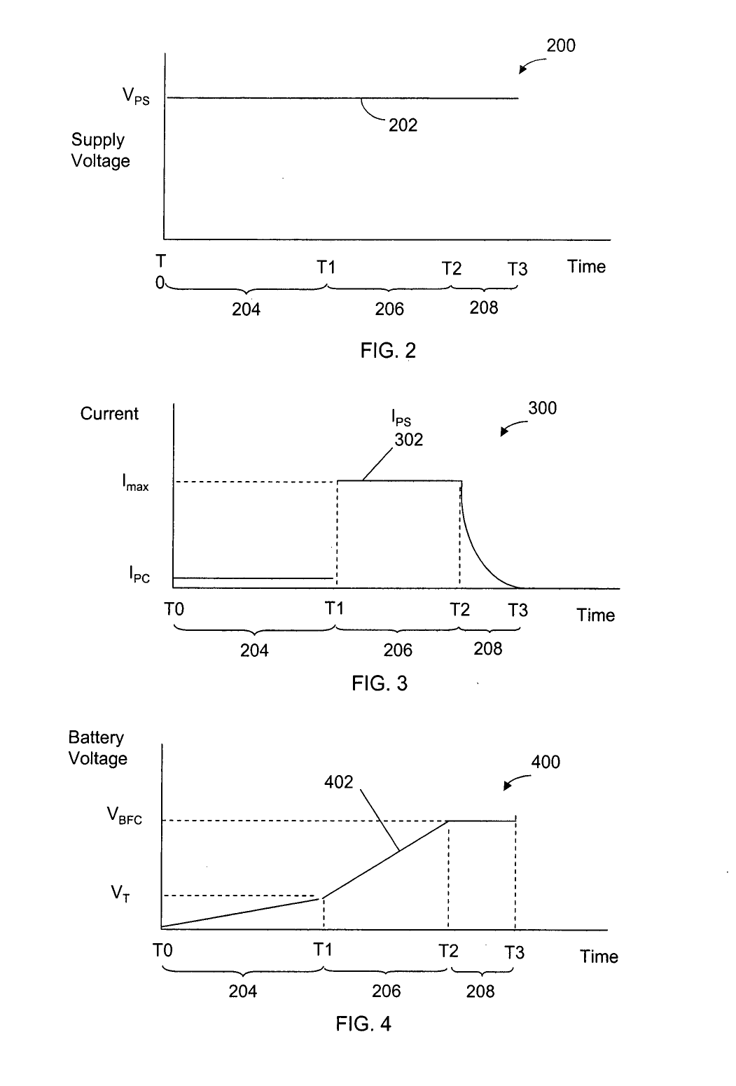

FIGS. 2-4 respectively show graphs 200, 300, and 400 of waveforms related to the charging of battery 102 according to charging system 100 over three charging time phases 204, 206, and 208. First phase 204 may be considered a pre-charge phase for battery 102. Second and third phases 206 and 208 may be considered charge phases for battery 102. Second phase 206 may be considered a constant current phase, while third phase 208 may be considered a constant voltage phase, as further described below. First phase, second phase, and third phase, may equivalently be termed phase 1, phase 2, and phase 3, respectively.

Graph 200 shows a power supply voltage (V_{PS}) waveform 202 representative of a power supply voltage supplied by power supply 106 to charger 108. As shown by waveform 202, a constant voltage is supplied by power supply 106 throughout all phases of charging. Graph 300 shows a power supply current (I_{PS}) waveform 302 representative of the power supply current supplied to charger 108. Graph 400 shows a battery voltage waveform 402 representative of the voltage of battery 102 as battery 102 is charged by charger 108.

In first phase 204, as indicated in FIG. 4 by waveform 402, a voltage across battery 102 is relatively low. Because battery 102 is substantially depleted, a full charging current cannot be received by battery 102 without adverse affects. Thus, during first phase 204, charger 108 demands a low pre-charge current, shown as I_{PC} in FIG. 3, to slowly charge battery 102 to a level where it can be substantially charged (during the charge phases 206 and 208). After the voltage across battery 102 reaches a threshold voltage, shown as V_{T} in FIG. 4, second phase 206 is reached. During second phase 206, charger 108 demands a relatively larger charger current, shown as Iₘₐₓ on waveform 302 in FIG. 3, so it can increase a charge rate of battery 102. For instance, in an example rechargeable battery, V_{T} may be 3 Volts, and I_{PC} may be equal to Iₘₐₓ÷10. Iₘₐₓ is the largest charging current that can typically be transmitted to battery 102 by charger 108. As shown by waveform 302, power supply 106 satisfies the current demanded by charger 108 by supplying a current equal to Iₘₐₓ.

As shown in FIG. 4, the voltage across battery 102 increases while being charged by Iₘₐₓ during second phase 206. Second phase 206 ends when the voltage across battery 102 is very near a fully charged battery voltage (V_{BFC}), as shown for waveform 402 in FIG. 4, and third phase 208 is therefore reached. In third phase 208, the voltage across battery 102, as represented by waveform 402, is equal to V_{BFC}. Charger 108 demands an exponentially decaying current, so that charger 108 can cause battery 102 to reach, but not exceed, V_{BFC}. Thus, as indicated by waveform 302 in FIG. 3, in accordance with the exponentially decaying current demand from charger 108, the power supply current supplied by power supply 106 decreases exponentially until the end of third phase 208. As indicated by waveform 402, at the end of third phase 208, battery 102 is fully charged to V_{BFC}. For example, V_{BFC} may be equal to 4.2 Volts, or other value, depending on the particular rechargeable battery configuration.

In an embodiment, charger 108 may terminate phase 3 of charging by observing the current being supplied to battery 102 has fallen below a predefined value. Alternatively, charger 108 may limit the extent of phase 3 through the use of a timer. Charger 108 may measure how long phase 3 has lasted and terminate charging after a certain time has elapsed.

Conventionally, as shown in FIG. 2, power supply 106 supplies charger 108 with a fixed output voltage for all modes of operation. In an embodiment, power supply 106 is configured such that the power supply voltage, V_{PS}, exceeds the voltage required by charger 108 to charge battery 102 during all phases of charging. For example, in an embodiment the lockout voltage (V_{LO}) is 3.5 Volts, the dropout voltage (V_{DO}) is 0.2 Volts when the charge current is equal to Iₘₐₓ during phase 2, and the maximum voltage of battery 102 during phase 2, which also the highest possible voltage of battery 102 at any time during charging, is 4.2 Volts. In such an embodiment, the minimum voltage to charge battery 102 may range from 3.5 Volts (i.e., the lockout voltage) to 4.4 Volts (when battery 102 has just reached its maximum voltage at the end of phase 2). Accordingly V_{PS} may be set to 5 Volts to ensure the voltage required by charger 108 is met at all times of charging battery 102. Since the voltage of battery 102 will not rise above the fully charged voltage (i.e., 4.2 Volts) and the dropout voltage remains at approximately 0.2 Volts, a power supply voltage 5 Volts will remain sufficient for charger 108 to charge battery 102.

Charger 108 determines when to switch the mode of operation from first phase 204 (shown between T0 and T1 in FIGS. 2-4), to second phase 206 (shown between T1 and T2), and finally to third phase 208 (shown between T2 and T3). Heat generated by charger 108 is proportional to the product of the current through charger 108, and a voltage across charger 108. The voltage across charger 108 is the difference between the power supply voltage shown in FIG. 2 as waveform 202, and the battery voltage shown in FIG. 4 as waveform 402. Thus, the heat generated by charger 108 may be relatively low during first phase 204, when the current through charger 108 is relatively low, although the voltage across charger 108 is high. The heat generated by charger 108 is higher during second and third phases 206 and 208, when the current through charger 108 is highest, and the voltage across charger 108 is still high.

As described above, charger 108 may be a linear IC charger. Linear IC chargers are frequently used in mobile devices, such as mobile device 104, because of their small size. However, heat generated by linear IC battery chargers in the manner just described can be a problem, potentially causing damage to the mobile device. Embodiments of the present invention solve this problem, by reducing heat generated by chargers in mobile devices.

Example Limited Power Supply Embodiments

In an embodiment, a power supply voltage for a charging circuit is limited (e.g., reduced) as compared to conventional charging configurations. The limited power supply voltage is applied to the charging circuit, such that there is a reduced voltage drop across the charging circuit (i.e., between the input limited power supply voltage and an output charging voltage for the battery). The charging circuit may be a conventional battery charging circuit, such as a linear IC charger. The reduced voltage drop across the charging circuit results in less heat generated by the charging circuit. In alternate embodiments, a current supplied to the charger may also be reduced to reduce the heat generated by the charging circuit.

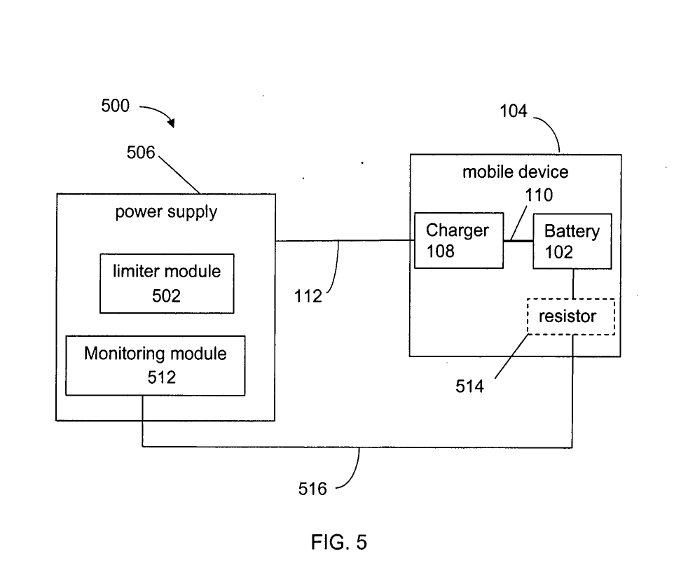

FIG. 5 shows an example charging system 500, according to an embodiment of the present invention. Charging system 500 includes a power supply 506 and mobile device 104. Power supply 506 includes a limiter module 502 and a monitoring module 512. Monitoring module 512 is coupled to battery 102 through a coupling 516 and optionally through a resistor 514. Resistor 514 (e.g., a resistor with a high resistance) may prevent damage to monitoring module 512 and power supply 506 due to a possible short. Power supply 506 supplies charger 108 with a power supply current and voltage through coupling 112. Limiter module 502 is configured to limit the power supply voltage of limited power supply 506 based on observations by monitoring module 512. Monitoring module 512 may monitor the voltage of battery 102 continuously and provide observations regarding the voltage of battery 102 continuously. This may allow limited power supply 506 to continuously update the limited power supply voltage. Alternatively, monitoring module 512 may be a sampling device that samples the voltage of battery 102 at discrete time intervals.

As shown in FIG. 5, limited power supply 506 is located outside of mobile device 104. In an embodiment, placing limited power supply 506 outside of mobile device 104 saves space in mobile device 104 and prevents heat generated by power supply 506 from affecting mobile device 104.

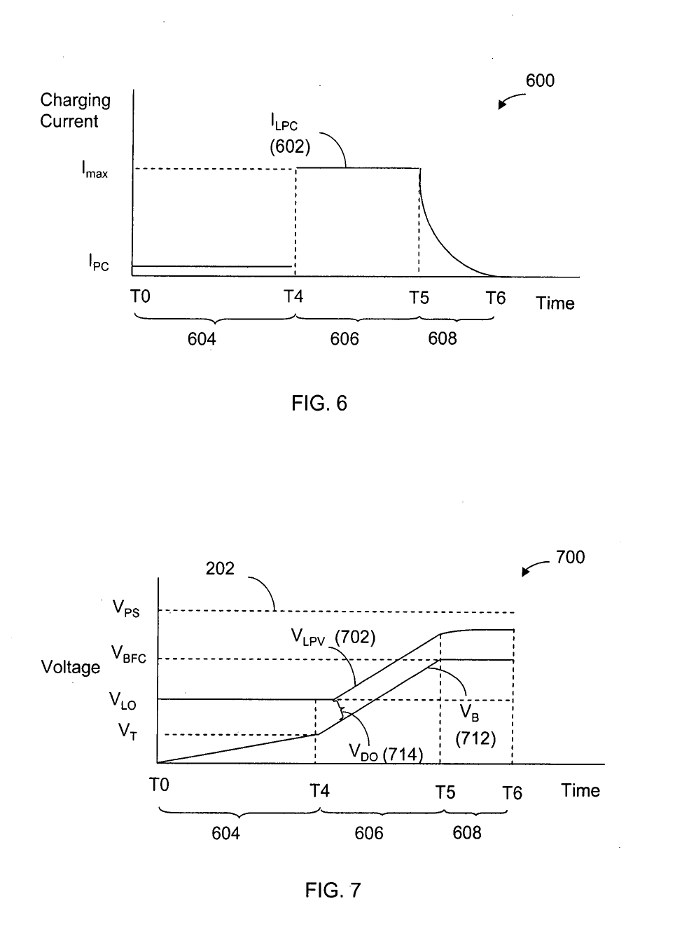

In the embodiment of FIG. 5, power supply 506 functions as a voltage controlled power supply during all phases of charging. In such an embodiment, power supply 506 is configured to satisfy the current demands of charger 108. In contrast to power supply 106, described with reference to FIG. 1, the power supply voltage of power supply 506 is not pre-determined, but is updated based on the voltage of battery 102. The operation of charging system 500 will be described with reference to FIGS. 6 and 7.

FIGS. 6 and 7 respectively show graphs 600 and 700 of waveforms related to the charging of battery 102, according to an example embodiment of the present invention. Similar to FIGS. 2-4 described above, FIGS. 6 and 7 relate to charging battery 102 over three charging time phases 604, 606, and 608, similar to phases 204, 206, and 208 described above.

FIG. 6 shows waveform 602 (I_{LPC}) representative of the power supply current supplied to charger 108 by limited power supply 506 through coupling 112.

In phase 1 of charging (i.e., phase 604), charger 108 demands relatively low current, I_{PC}, from limited power supply 506. As shown by waveform 602, limited power supply 506 satisfies this demand by supplying current I_{PC} to charger 108 through coupling 508. In phase 2 of charging (i.e., phase 606), charger 108 demands a relatively high current, Iₘₐₓ, from limited power supply 506. As shown by waveform 602, limited power supply 506 also satisfies this current demand by supplying current Iₘₐₓ to charger 108. In the final phase of charging (i.e., phase 608), the current demanded by charger 108 decays exponentially. Again, as shown by waveform 602, this decaying current demand is satisfied by limited power supply 506.

FIG. 7 shows a limited power supply voltage waveform 702 (V_{LPV}) representative of the power supply voltage of power supply 506. FIG. 7 also shows waveform 712 (V_{B}) representative of the voltage of battery 102

In the embodiment of FIG. 5, limited power supply 506 is configured such that the power supply voltage remains at substantially the minimum voltage required by charger 108 to charge battery 102 during all phases of charging. Limiter module 502 updates the power supply voltage based on observations of the voltage of battery 102 taken by monitoring module 512. Thus, by measuring the voltage of battery 102, limiter module 502 sets the power supply voltage, V_{LPV}, to V_{LO} when V_{LO}>V_{B}+V_{DO} and V_{B}+V_{DO} when V_{B}+V_{DO}≧V_{LO}. In an embodiment, limiter module 502 includes a voltage regulator that may control or limit the power supply voltage.

As shown in FIG. 7, the power supply voltage of limited power supply 506 (V_{LPV}) remains at the lockout voltage (V_{LO}) until the voltage of battery 102 (V_{B})+V_{DO}=V_{LO}, then remains above V_{B} by a constant value of V_{DO} (shown as 714 in FIG. 7) throughout the duration of charging.

Thus, unlike power supply 106 shown in FIG. 1, limited power supply 506 updates its power supply voltage based on the voltage of battery 102. Doing so limits the voltage drop across charger 108, thereby reducing the power and heat dissipated by charger 108.

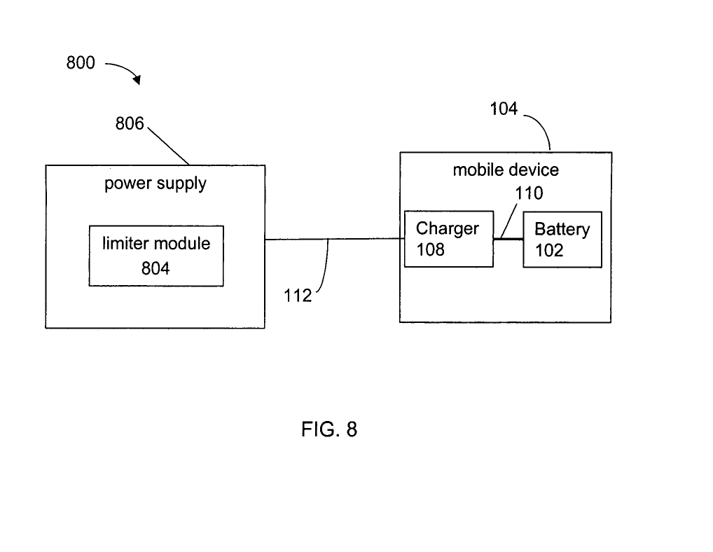

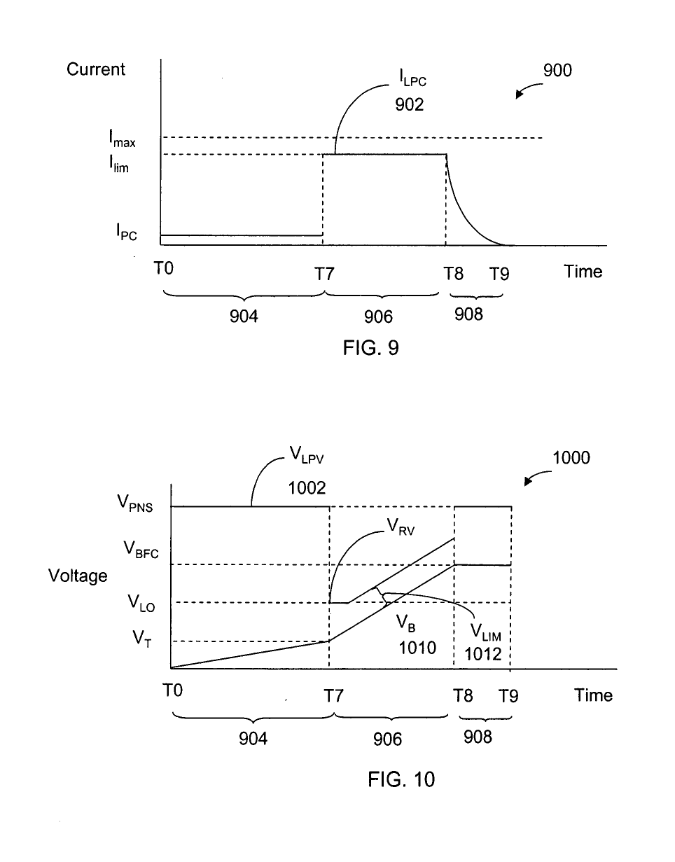

FIG. 8 shows an example charging system 800, according to an embodiment of the present invention. Charging system 800 includes mobile device 104 and a power supply 806. Limited power supply 806 includes a limiter module 802. Limited power supply 806 powers charger 108 through coupling 112. Limiter module 802 is configured to limit the power supply voltage that limited power supply 806 supplies to charger 108. In an embodiment, limiter module 802 includes a voltage regulator. The operation of charging system 800 will be described with reference to FIGS. 9 and 10.

FIGS. 9 and 10 respectively show graphs 900 and 1000 of waveforms related to the charging of battery 102, according to an example embodiment of the present invention. Similar to FIGS. 2-4 described above, FIGS. 9 and 10 relate to charging battery 102 over three charging time phases 904, 906, and 908, similar to phases 204, 206, and 208 described above. FIG. 9 shows waveform 902 (I_{LPC}) representative of the limited power supply current supplied to charger 108 by limited power supply 806. FIG. 10 shows waveform 1002 (V_{LPV}) representative of the power supply voltage of limited power supply 806 and waveform 1010 (V_{B}) representative of the voltage of battery 102.

In contrast to limited power supply 506, described with reference to FIG. 5, limited power supply 806 is configured to operate as a current limited power supply. Limited power supply 806 is configured to supply a current only up to a maximum value, shown as Iₗᵢₘ in FIG. 9. Thus, a current demand by charger 108 greater than Iₗᵢₘ is not met.

In an embodiment, limited power supply 806 is configured to supply a predefined power supply voltage that exceeds a voltage requirement of charger 108 when a current demand of charger 108 is below Iₗᵢₘ. As shown in FIG. 10, the limited power supply voltage (V_{LPV}) remains at V_{PNS} during phases 1 and 3 when the current demand of charger 108 remains below Iₗᵢₘ. In an embodiment, V_{PNS} exceeds the voltage required by charger 108 to charge battery 102 at any time during the charging of battery 102. In an embodiment, V_{PNS} may be greater the sum of battery 102 when fully charged and the dropout voltage of charger 108. For example, in an embodiment the lockout voltage (V_{LO}) is 3.5 Volts, the dropout voltage (V_{DO}) is 0.2 Volts, and the voltage of battery 102 when fully charged, is 4.2 Volts. In such an embodiment V_{PNS} may be preprogrammed to be 5 Volts to ensure the voltage required by charger 108 to charger battery 102 is always met. Since the voltage of battery 102 will not rise above the fully charged voltage (i.e., 4.2 Volts) and the dropout voltage remains at approximately 0.2 Volts, a power supply voltage 5 Volts will remain sufficient for charger 108 to charge battery 102.

In phase 1 of charging (i.e., phase 904), charger 108 demands a relatively low current, I_{PC}, that is below Iₗᵢₘ. As shown by waveform 902 in FIG. 9, limited power supply 806 satisfies this current demand by supplying charger 108 with current I_{PC}.

In phase 2 of charging, charger 108 demands a relatively larger current, Iₘₐₓ. As shown by waveform 902, the limited power supply current, I_{LPC}, remains at Iₗᵢₘ and below Iₘₐₓ during phase 2. Limited power supply 806 is preprogrammed with a maximum current, Iₗᵢₘ, that is below Iₘₐₓ. In other words, limited power supply 806 configured so that Iₗᵢₘ will be less than Iₘₐₓ. In an embodiment, Iₘₐₓ is 1 Amperes and Iₗᵢₘ is 0.9 Amperes.

As shown in FIG. 10, limiter module 802 responds to the increased current demand from charger 108 in phase 2, which is larger than Iₗᵢₘ, by lowering the limited power supply voltage, (V_{LPV}) of limited power supply 806 to a reduced voltage (V_{RV}) so that charger 108 charges battery 102 with a current equal to Iₗᵢₘ rather than Iₘₐₓ. As shown V_{RV} may be expressed as:

V_{RV}=V_{LO} if V_{LO}>V_{B}+V_{LIM} and, V_{B}+V_{LIM} if V_{B}+V_{LIM}≧V_{LO},

where V_{RV} is the power supply voltage of limited power supply 806 during phase 2,

V_{B} is the voltage of the battery during phase 2, and

V_{LIM} is the voltage difference between battery 102 and the limited power supply voltage of limited power supply 806 (i.e., the voltage drop across charger 108) that allows charger 108 to charge battery 102 with a current equal to Iₗᵢₘ rather than Iₘₐₓ.

In an embodiment, charger 108 includes a pass element that regulates the current and voltage used to charge battery 102. By reducing the limited power supply voltage to V_{RV}, the pass element is effectively “starved” so that charger 108 charges battery 102 with Iₗᵢₘ rather than Iₘₐₓ. In an embodiment, V_{LIM} is the smallest voltage drop across the pass element so that charger 108 charges battery 102 with Iₗᵢₘ rather than Iₘₐₓ.

In an embodiment, V_{LIM}, is also the dropout voltage of charger 108, V_{DO}.

The operation of limited power supply 806 in phase 2 (i.e., when charger 108 demands a current larger than Iₗᵢₘ) once V_{B}+V_{DO} is equal to or greater than V_{LO} may be described as a feedback system. As the voltage of battery 102 increases, the voltage drop across charger 108 drops below V_{LIM}. In response to this, limiter module 802 increases the limited power supply voltage to the voltage required so that the voltage drop across charger 108 returns to V_{LIM}. Thus, the limited power supply voltage of limited power supply 806 is effectively automatically updated based on changes in the voltage of battery 102. In doing so, limited power supply 806 does not monitor the voltage of battery 102 to update the limited power supply voltage. Rather, the updating of the limited power supply voltage is a result of a current demand that is larger than Iₗᵢₘ. As shown by FIG. 10, V_{LPV} tracks upward with V_{B} and the voltage difference between V_{LPV} and V_{B} remains substantially equal to V_{LIM}.

In the embodiment of FIG. 10, V_{LIM} is assumed to be constant with respect to the voltage of battery 102. In alternate embodiments, V_{LIM} may change as the voltage of battery 102 increases. As would be appreciated to those skilled in the relevant art(s), such an embodiment would result in waveform 1002 no longer being perfectly parallel to waveform 1010 over phase 2 (as shown in FIG. 10), but waveform 1002 would still increase as waveform 1010 increases.

During phase 3 of charging, limiter module recognizes that the current demand has fallen below Iₗᵢₘ. As shown by FIG. 10, in response to this decreased demand, limited power supply 806 V_{LPV} returns to normal operation and supplies V_{PNS} over the duration of phase 3. As shown by FIG. 9, the current supplied to charger 108, I_{LPC}, decays exponentially during phase 3, satisfying the current demand of charger 108.

Thus, the power and heat dissipated by charger 108 over phase 2 is diminished in two ways compared to conventional charging. The current through charger 108 remains Iₗᵢₘ rather than Iₘₐₓ and the input voltage to charger 108 remains smaller than the power supply voltage of a conventional power supply. Unlike limited power supply 506, however, limited power supply 806 does not require the voltage of the battery to be monitored to lower its supply voltage. Rather, limited power supply 806 lowers its supply voltage in response to a current demand that is beyond its predefined maximum supply current.

In FIGS. 7 and 10, V_{LO} is shown to be an arbitrary voltage. As would be apparent to those skilled in the relevant art(s), V_{LO} may be greater than or less than the arbitrary levels shown in FIGS. 7 and 10.

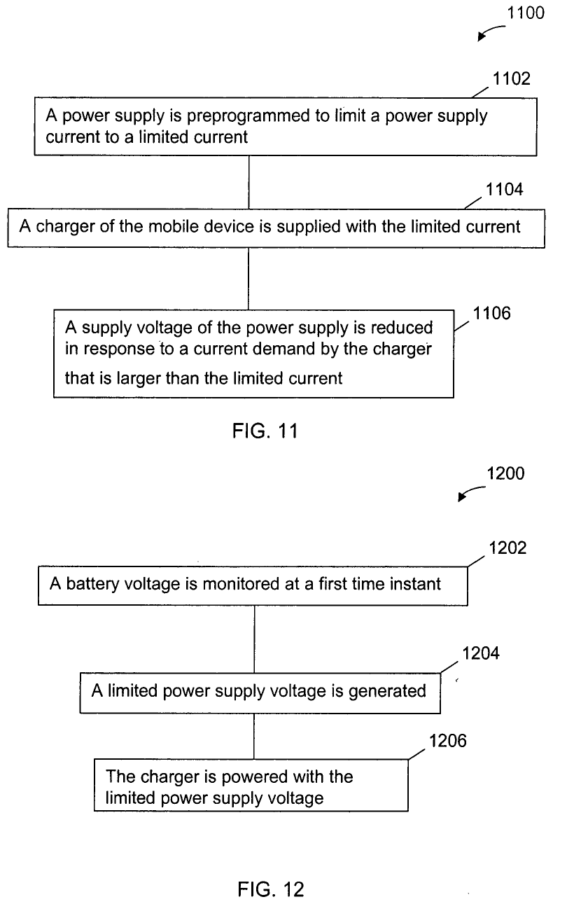

The example embodiments of the present invention are also described in flowcharts 1100 and 1200 shown in FIGS. 11 and 12 respectively.

### Example Mobile Device Embodiments

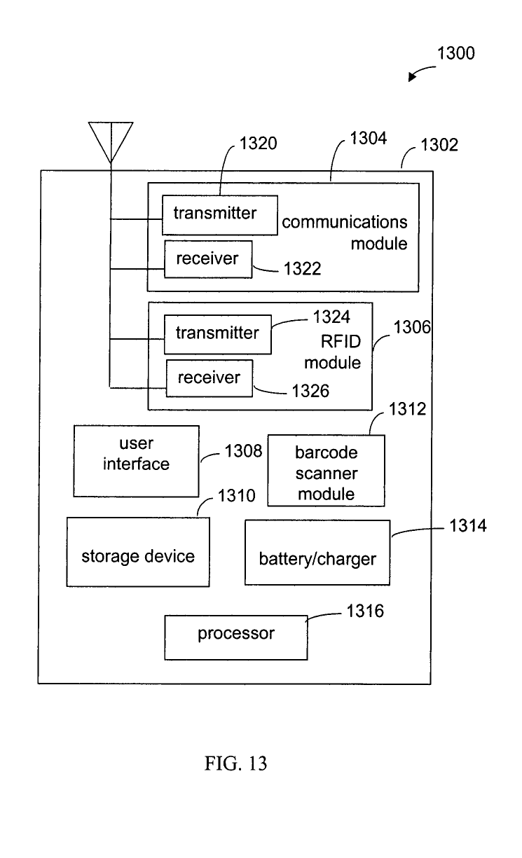

Mobile device 104 may be one of a variety of mobile device types, including a RFID reader (fixed or mobile), a handheld barcode scanner, a handheld computer, a cell phone, a pen or wand, a handheld music player, other device mentioned herein, combination of devices, or other known mobile device type. FIG. 13 shows a mobile device 1300, including various example components and/or modules, as an example embodiment of mobile device 104. In FIG. 13, mobile device 1300 includes a communications module 1304, an RFID module 1306, a user interface 1308, a storage device 1310, a barcode scanner module 1312, a battery/charger 1314, a processor 1316, and an antenna 1318, contained by a housing 1302. Mobile device embodiments may include any one or more of these components/modules in any combination, and/or may include alternative components/modules.

As shown in FIG. 13, communications module 1304 includes a transmitter 1320 and a receiver 1322, and RFID module 1306 includes a transmitter 1324 and a receiver 1326. In an alternative embodiment, communications module 1304 and RFID module 1306 may share a common receiver and transmitter (or transceiver).

RFID module 1306 is configured to perform communications with RFID tags via antenna 1318, such as described above for reader 102 in FIG. 2. Communications module 1304 is configured to enable mobile device 1300 to communicate with a remote entity via antenna 1318. For example, communications module 1304 may be configured to communicate with a communications network in a wired or wireless fashion, including a personal area network (PAN) (e.g., a BLUETOOTH network), a local area network (e.g., a wireless LAN, such as an IEEE 802.11 network), and/or a wide area network (WAN) such as the Internet.

A user interacts with mobile device 1300 through user interface 1308. For example, user interface 1308 can include any combination of one or more finger-operated buttons (such as a “trigger”), a keyboard, a graphical user interface (GUI), indicator lights, and/or other user input and display devices, for a user to interact with mobile device 1300, to cause mobile device 1300 to operate as described herein. User interface 1308 may further include a web browser interface for interacting with web pages and/or an E-mail tool for reading and writing E-mail messages.

Storage device 1310 is used to store information/data for mobile device 1300. Storage device 1310 can be any type of storage medium, including memory circuits (e.g., a RAM, ROM, EEPROM, or FLASH memory), a hard disk/drive, a floppy disk/drive, an optical disk/drive (e.g., CDROM, DVD, etc), etc., and any combination thereof. Storage device 1310 can be built-in storage of mobile device 1300, and/or can be additional storage installed (removable or non-removable) in mobile device 1300.

Battery/charger 1314 includes a battery, such as battery 102, and a battery charger, such as charger 108, described above. Battery/charger 1314 may also include supplemental power sources suitable for mobile device 1300, including a power source interface (e.g., for external DC or AC power) for providing power supply signal 112 and/or limited power supply signal 504, described above.

Barcode scanner module 1312 is configured to read optically readable symbols. In embodiments, barcode scanner module 1312 may include any type of barcode scanner front end, including a light source (e.g., and photodiode), a laser scanner, a charge coupled device (CCD) reader, and/or a 2-D symbol imaging scanner (e.g., a video camera). Barcode scanner module 1312 may further include processing logic for decoding received symbol information.

Processor 1316 may be present to execute control logic (e.g., software) to cause processor 1316 to perform functions of mobile device 1300.

Note that, depending on the particular application for the mobile device, mobile device 1300 may include additional or alternative components. Furthermore, note that alternatively, embodiments of the charging system described herein may be applied in devices other than mobile devices (e.g., may be applied in devices that remain generally stationary).

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A system for charging a battery of a mobile device, comprising:
a limited power supply, including:
a limiter module; and
a monitoring module;
wherein the limiter module is configured to limit a power supply voltage of the limited power supply based at least on observations of a battery voltage taken by the monitoring module.

2. The system of claim 1, wherein the monitoring module is coupled to the battery of the mobile device through a resistor.

3. The system of claim 1, wherein the limiter module is configured to update the power supply voltage so that the power supply voltage remains substantially equal to the minimum voltage required by a charger of the mobile device to charge the battery.

4. The system of claim 3, wherein the limiter module is configured to update the power supply voltage according to:
V_{LPV}=V_{LO} when V_{LO}>V_{B}+V_{DO}, and V_{B}+V_{DO}, when V_{B}+V_{DO}≧V_{LO}, where
V_{LPV} is the power supply voltage,
V_{B} is the voltage of the battery,
V_{LO} is the lockout voltage of the charger, and
V_{DO} is the dropout voltage of the charger.

5. The charging system of claim 1, wherein the power supply is external to the mobile device.

6. The charging system of claim 1, wherein the power supply is mounted in the mobile device.

7. The charging system of claim 1, wherein the limiter module comprises a voltage regulator.

8. A method for charging a battery in a mobile device, comprising:
monitoring a battery voltage at a first time instant;
generating a limited power supply voltage, wherein the limited power supply voltage is generated based at least on the battery voltage observed at the first time instant, wherein the limited power supply voltage level is substantially equal to a minimum voltage level required by a charger to charge the battery at the first time instant; and
powering the charger with the limited power supply voltage.

9. The method of claim 8, further comprising:
monitoring the battery voltage at a second time instant; and
updating the limited power supply voltage based on at least the battery voltage observed at the second time instant, wherein the updated limited power supply voltage level is substantially equal to a minimum voltage level required by a charger to charge the battery at the second time instant.

10. The method of claim 8, wherein the limited power supply voltage is generated according to:
V_{LPV}=V_{LO} when V_{LO}>V_{B}+V_{DO}, and V_{B}+V_{DO}, when V_{B}+V_{DO}>V_{LO}, where
V_{LPV} is the power supply voltage,
V_{B} is the voltage of the battery,
V_{LO} is the lockout voltage of the charger, and
V_{DO} is the dropout voltage of the charger.
